(19) United States
(12) Patent Application Publication
(10) Pub. No.: US 2023/0156887 A1
(43) Pub. Date: May 18, 2023

(54) High Voltage Controller

(71) Applicant: Guang Zhou Ting Shen Electric Co., Ltd., Guang zhou (CN)

(72) Inventor: Chia-Chun WANG, Hsinchu County (TW)

(21) Appl. No.: 17/529,855

(22) Filed: Nov. 18, 2021

(51) Int. Cl. H05B 45/37; H05B 45/48; F21V 23/00; F21S 4/20; F21V 3/02; H05B 47/10

(52) U.S. Cl. CPC H05B 45/37; F21S 4/20; F21V 3/02; F21V 23/001; H05B 45/48; H05B 47/10; F21Y 2115/10

(57) ABSTRACT

A high voltage controller contains: a casing and a wire receiving orifice defined on a predetermined position of the casing and configured to receive a preferred wire and to connect with a predetermined light-emitting diode (LED) light source. The casing further includes an electric circuit board accommodated therein, and the electric current board includes a wave filter, a rectifier, an inverter which are arranged from a voltage input end to a voltage output end of the electric circuit board, such that the wave filter and the rectifier rectify electric currents, and an alternating current (AC) voltage is rectified into a direct current (DC) voltage. The inverter includes at least one transistor arranged in a matrix so as to invert into the AC voltage, and the AC voltage is outputted, hence the AC voltage and the DC voltage are transformed repeatedly to obtain no-shaking lights.

### FIELD OF THE INVENTION

The present invention relates to a high voltage controller, and more particularly to the high voltage controller which facilitates no-shaking lights of a light string, a bulb, or a light.

### BACKGROUND OF THE INVENTION

A conventional high voltage controller cannot control a light string, a bulb, or a light to emit lights which do not shake.

The present invention has arisen to mitigate and/or obviate the afore-described disadvantages.

### SUMMARY OF THE INVENTION

The primary objective of the present invention is to provide a high voltage controller which facilitates no-shaking lights of a light string, a bulb, or a light.

To obtain above-mentioned objectives, a high voltage controller provided by the present invention contains: a casing and a wire receiving orifice defined on a predetermined position of the casing and configured to receive a preferred wire and to connect with a predetermined light-emitting diode (LED) light source.

The casing further includes an electric circuit board accommodated therein, and the electric current board includes a wave filter, a rectifier, an inverter which are arranged from a voltage input end to a voltage output end of the electric circuit board, such that the wave filter and the rectifier rectify electric currents, and an alternating current (AC) voltage is rectified into a direct current (DC) voltage.

The inverter includes at least one transistor arranged in a matrix so as to invert into the AC voltage, and the AC voltage is outputted, hence the AC voltage and the DC voltage are transformed repeatedly to obtain no-shaking lights..

### BRIEF DESCRIPTION OF THE DRAWINGS

FIG. 1 is a perspective view showing the assembly of a high voltage controller according to a preferred embodiment of the present invention.

FIG. 2 is another perspective view showing the assembly of the high voltage controller according to the preferred embodiment of the present invention.

FIG. 3 is a block diagram showing the assembly of an electric circuit board of the high voltage controller according to the preferred embodiment of the present invention.

FIG. 4 is a circuit diagram showing the assembly of the electric circuit board of the high voltage controller according to the preferred embodiment of the present invention.

### DETAILED DESCRIPTION OF THE PREFERRED EMBODIMENTS

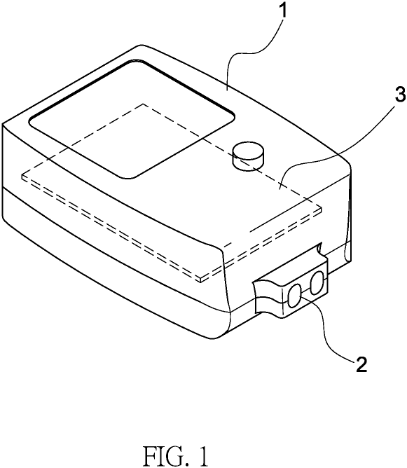

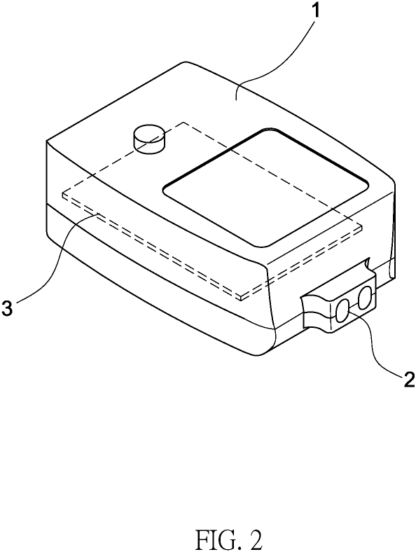

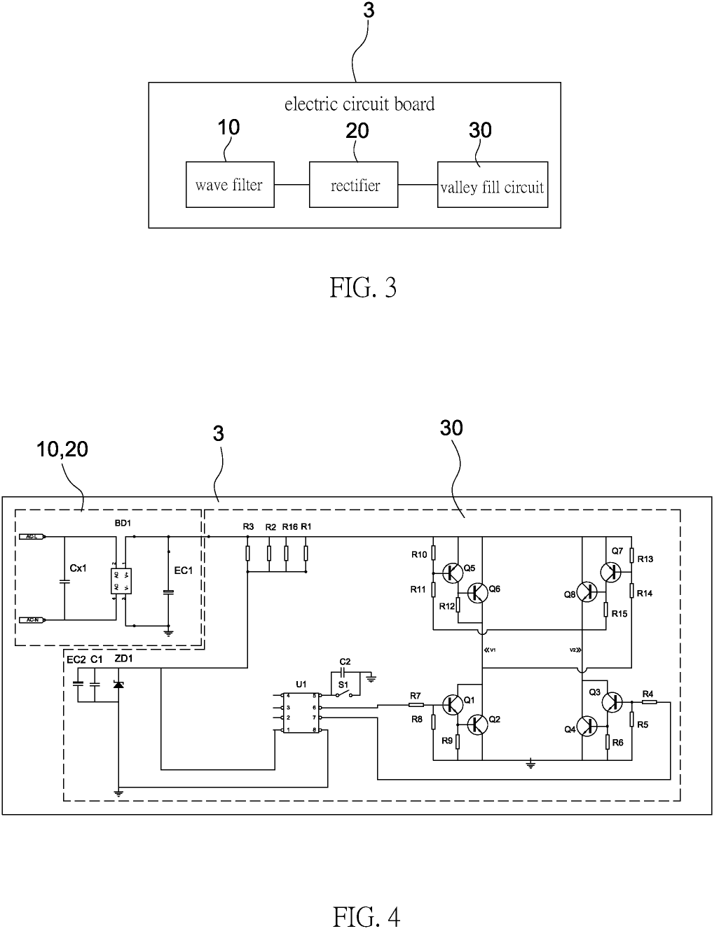

With reference to FIGS. 1-4, a high voltage controller according to a preferred embodiment of the present invention comprises: a casing 1 and a wire receiving orifice 2 defined on a predetermined position of the casing 1 and configured to receive a preferred wire and to connect with a predetermined light-emitting diode (LED) light source, wherein the casing 1 further includes an electric circuit board 3 accommodated therein, and the electric current board 3 includes a wave filter 10, a rectifier 20, an inverter 30 which are arranged from a voltage input end to a voltage output end of the electric circuit board 3, such that the wave filter 10 and the rectifier 20 rectify electric currents, and an alternating current (AC) voltage is rectified into a direct current (DC) voltage. The inverter 30 includes at least one transistor arranged in a matrix. In this embodiment, the inverter 30 includes eight transistors arranged in the matrix so as to invert into the AC voltage, and the AC voltage is outputted, hence the AC voltage and the DC voltage are transformed repeatedly to obtain no-shaking lights.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A high voltage controller comprising:
a casing and a wire receiving orifice defined on a predetermined position of the casing and configured to receive a preferred wire and to connect with a predetermined light-emitting diode (LED) light source;
wherein the casing further includes an electric circuit board accommodated therein, and the electric current board includes a wave filter, a rectifier, an inverter which are arranged from a voltage input end to a voltage output end of the electric circuit board, such that the wave filter and the rectifier rectify electric currents, and an alternating current (AC) voltage is rectified into a direct current (DC) voltage;
wherein the inverter includes eight transistors arranged in a matrix so as to invert into the AC voltage, and the AC voltage is outputted, hence the AC voltage and the DC voltage are transformed repeatedly to obtain no-shaking lights.
